(19) United States
(12) Patent Application Publication
(10) Pub. No.: US 2002/0101503 A1
(43) Pub. Date: Aug. 1, 2002

(54) Laser imaging system with variable energy flux densities

(76) Inventors: John Gary Sousa, Hollis, NH (US); Mark Fernald, Amherst, NH (US)

Correspondence Address: TESTA, HURWITZ & THIBEAULT, LLP, HIGH STREET TOWER, 125 HIGH STREET, BOSTON, MA, 02110, US

(21) Appl. No.: 09/775,133

(22) Filed: Feb. 1, 2001

(51) Int. Cl. B41J 27/00

(52) U.S. Cl. 347/256

(57) ABSTRACT

A variable filter arrangement is interposed within the optical path of an apparatus containing a source of imaging radiation directed along an optical path for imaging a recording construction. The variable filter arrangement facilitates selectable reduction in the output energy density of the radiation source without substantially altering the focal length of the optical path. The variable filter arrangement may utilize multiple independent lenses of varying energy density reduction levels or a filter of unitary construction with progressive densities so as to provide a selectable continuum for reduction in the output energy density of the imaging radiation.

### BACKGROUND OF THE INVENTION

1. Field of the Invention

The present invention relates to digital printing apparatus and methods, and more particularly to a system for modulating the energy density of the digitally controlled laser output.

2. Description of the Related Art

In offset lithography, a printable image is present on a printing member as a pattern of ink-accepting (oleophilic) and ink-repellent (oleophobic) surface areas. Once applied to these areas, ink can be efficiently transferred to a recording medium in the imagewise pattern with substantial fidelity. Dry printing systems utilize printing members whose ink-repellent portions are sufficiently phobic to ink as to permit its direct application. Ink applied uniformly to the printing member is transferred to the recording medium only in the imagewise pattern. Typically, the printing member first makes contact with a compliant intermediate surface called a blanket cylinder which, in turn, applies the image to the paper or other recording medium. In typical sheet-fed press systems, the recording medium is pinned to an impression cylinder, which brings it into contact with the blanket cylinder.

In a wet lithographic system, the non-image areas are hydrophilic, and the necessary ink-repellency is provided by an initial application of a dampening (or “fountain”) solution to the plate prior to inking. The fountain solution prevents ink from adhering to the non-image areas, but does not affect the oleophilic character of the image areas.

If a press is to print in more than one color, a separate printing member corresponding to each color is required. The original image is decomposed into a series of imagewise patterns, or “separations,” that each reflect the contribution of the corresponding printable color. The positions of the printing members are coordinated so that the color components printed by the different members will be in register on the printed copies. Each printing member ordinarily is mounted on (or integral with) a “plate” cylinder, and the set of cylinders associated with a particular color on a press is usually referred to as a printing station.

To circumvent the cumbersome photographic development, plate-mounting and plate-registration operations that typify traditional printing technologies, practitioners have developed electronic alternatives that store the imagewise pattern in digital form and impress the pattern directly onto the plate. Plate-imaging devices amenable to computer control include various forms of lasers. For example, U.S. Pat. Nos. 5,351,617 and 5,385,092 disclose ablative recording systems that use low-power laser discharges to remove, in an imagewise pattern, one or more layers of a lithographic printing blank, thereby creating a ready-to-ink printing member without the need for photographic development.

In accordance with those systems, laser output is guided from the diode to the printing surface and focused onto that surface (or, desirably, onto the layer most susceptible to laser ablation, which will generally lie beneath the surface layer) along an optical path. Other systems use laser energy to cause transfer of material from a donor to an acceptor sheet, to record non-ablatively, or as a pointwise alternative to overall exposure of photochemical plates through a photomask or negative. Both the ablative-type systems and transfer-type systems, referred to collectively as lithographic plate systems, require relatively high output energy density (about 485 mJ/cm²) as compared to the output energy density required to expose typical photochemical plates (about 80 to 180 mJ/cm²). Although ablation-type plates offer certain advantages over photochemical plates, a large existing installed base of photochemical recording systems has created a need in the marketplace for a single printing apparatus which can readily accommodate either type of system.

One approach to reducing the output energy density for photochemical systems is to interpose a filter medium, such as a neutral density filter, within the optical path. Unfortunately, introducing such a filter into the system also refracts the beam of imaging radiation and thereby changes the focal length of the optical path as a function of filter thickness. The optical path between the radiation source and the recording construction could be adjusted to accommodate the neutral density filter and correct the resulting focal length deviation, but once the filter is removed or retracted from the optical path to restore the radiation source to its original higher output energy density, the focal length of the optical path will once again require adjustment. Practical imaging equipment requires a rigidly constant focal length to maximize output radiation density and imaging performance combined with the practical capacity to toggle between high and low output energy densities, for laser and photochemical plates, respectively.

### DESCRIPTION OF THE INVENTION

### BRIEF SUMMARY OF THE INVENTION

Through the use of novel means for tuning the output energy density of the source of imaging radiation, the present invention enables dual usage of a single printing apparatus for two or more applications with disparate output energy density requirements, while maintaining a constant focal length along the optical path. It should be noted that the term “imaging” herein refers generally to a permanent alteration to the affinity characteristics of a printing plate and includes but is not limited to ablation of a recording layer (in an ablation-type plate), transfer of donor material to an acceptor sheet (in a transfer-type plate) or exposure of photochemical plates.

In a first aspect, the invention improves upon conventional configurations for imaging a recording construction by interposing a variable filter arrangement within the optical path to selectably modify the effective output energy density without substantially altering the focal length of the optical path. This arrangement permits the focal length of the optical path to remain constant for a selectable range of output power energy densities and obviates the need to disturb the physical displacement of either the radiation source or focusing assemblies.

In a preferred embodiment, the variable filter arrangement interposed within the optical path includes a neutral density filter and a substantially transparent window having the same thickness. In addition, a slideable toggle may selectably interpose either the neutral density filter or the transparent window within the optical path and thereby facilitate selectable reduction in the output energy density without substantially altering the focal length of the optical path. In a related aspect of the invention, an optical window is provided adjacent to the variable filter to protect the variable filter arrangement during movement thereof and, generally, from a potentially harsh ambient environment.

In a second aspect, the invention relates to a method of altering the output energy density of radiation directed along an optical path toward a recording construction. A variable density filter arrangement is interposed within the optical path for selectable reduction in the output energy density reaching the recording construction without altering the focal length of the optical path.

### BRIEF DESCRIPTION OF THE DRAWINGS

The foregoing discussion will be understood more readily from the detailed description of the invention, when taken in conjunction with the accompanying drawings, in which:

FIG. 1 schematically illustrates the basic components of the environment in which the invention is implemented;

FIG. 2 is an exploded isometric view of an optical indexing array; and

FIGS. 3 and 4 are elevational views of optical indexing array in accordance with the invention.

### DETAILED DESCRIPTION OF THE PREFERRED EMBODIMENT

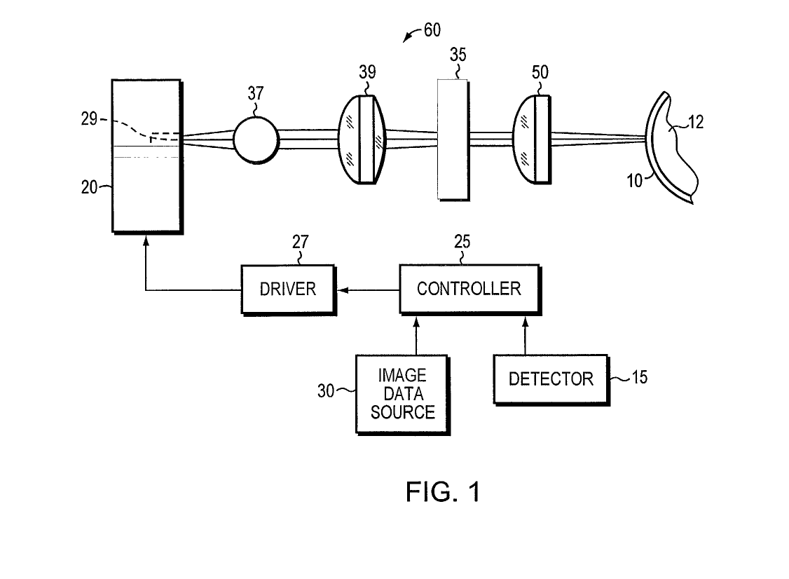

The basic components of an environment to which the invention may be applied are schematically illustrated in FIG. 1. A recording medium 10, such as a lithographic plate blank or other graphic-arts construction, is affixed to a support during the imaging process. In the depicted implementation, that support is a cylinder 12, around which recording medium 10 is wrapped. If desired, cylinder 12 may be straightforwardly incorporated into the design of a conventional lithographic press, serving as the plate cylinder of the press. Cylinder 12 is supported in a frame and rotated by a standard electric motor or other conventional means. The angular position of cylinder 12 is monitored by a shaft encoder associated with a detector 15. The optical components of the invention, described hereinbelow, may be mounted in a writing head for movement on a lead screw and guide bar assembly that traverses recording medium 10 as it rotates. Axial movement of the writing head results from rotation of a stepper motor, which turns the lead screw and indexes the writing head after each pass over cylinder 12.

Imaging radiation, which strikes recording medium 10 so as to effect an imagewise scan, originates with one or more pumping laser diodes 20. The optical components discussed below concentrate the entire laser output onto recording medium 10 as a small feature, resulting in high effective power densities. A controller 25 operates a laser driver 27 to produce an imaging burst when the output slit 29 of laser 20 reaches appropriate points opposite recording medium 10; as discussed in U.S. Pat. No. 5,822,345, laser 20 may otherwise be maintained at a baseline, non-imaging energy level to minimize switching time. The driver preferably includes a pulse circuit capable of generating at least 40,000 laser-driving pulses/second, with each pulse being relatively short, i.e., on the order of microseconds.

Controller 25 receives data from two sources. The angular position of cylinder 12 with respect to the laser output is constantly monitored by detector 15, which provides signals indicative of that position to controller 25. In addition, an image data source (e.g., a computer) 30 also provides data signals to controller 25. The image data define points on recording medium 10 where image spots are to be written. Controller 25, therefore, correlates the instantaneous relative positions of laser 20 and recording medium 10 (as reported by detector 15) with the image data to actuate the appropriate laser drivers at the appropriate times during scan of recording medium 10. The driver and control circuitry required to implement this scheme is well-known in the scanner and plotter art; suitable designs are described in U.S. Pat. No. 5,174,205, commonly owned with the present application and hereby incorporated by reference.

The output of laser 20 pumps a laser crystal 35, and it is the emission of crystal 35 that actually reaches the recording medium 10. A series of lenses 37, 39 concentrate the output of laser 20 onto an end face 45 of crystal 35. Radiation disperses as it exits slit 29 of laser 20, diverging at the slit edges. Generally the dispersion (expressed as a “numerical aperture,” or NA) along the short or “fast” axis shown in FIG. 1 is of primary concern; this dispersion is reduced using a divergence-reduction lens 37. A preferred configuration is a completely cylindrical lens, essentially a glass rod segment of proper diameter; however, other optical arrangements, such as lenses having hemispheric cross-sections or which correct both fast and slow axes, can also be used to advantage.

A focusing lens 39 focuses radiation emanating from lens 37 onto end face 45 of laser crystal 35. The optical path between lenses 37 and 39 may be direct, or may instead proceed through a fiber-optic cable. Lens 39 may be a bi-aspheric lens. Generally, end faces 45, 47 have mirror coatings that limit the entry of radiation other than that originating from the pumping source, and trap the output radiation. In this way, the two coatings facilitate the internal reflections characteristic of laser amplification while preventing the entry of spurious radiation (see U.S. Pat. No. 5,990,925).

The highly collimated, low-NA output of crystal 35 is, finally, focused onto the surface (or an appropriate inner layer) of recording medium 10 by a lens 50, which may be a plano-convex lens (as illustrated) or other suitable optical arrangement. The laser, laser crystal and optical components are normally carried in a single elongated housing, and define an optical path 60. Recording medium 10 responds to the imaging radiation emitted by crystal 35, e.g., through ablation of an imaging layer, by non-ablative transfer of material from a donor to an acceptor sheet, or photochemical exposure. A typical commercial imaging device will have several of the assemblies shown in FIG. 1 arranged in parallel in order to reduce overall imaging time.

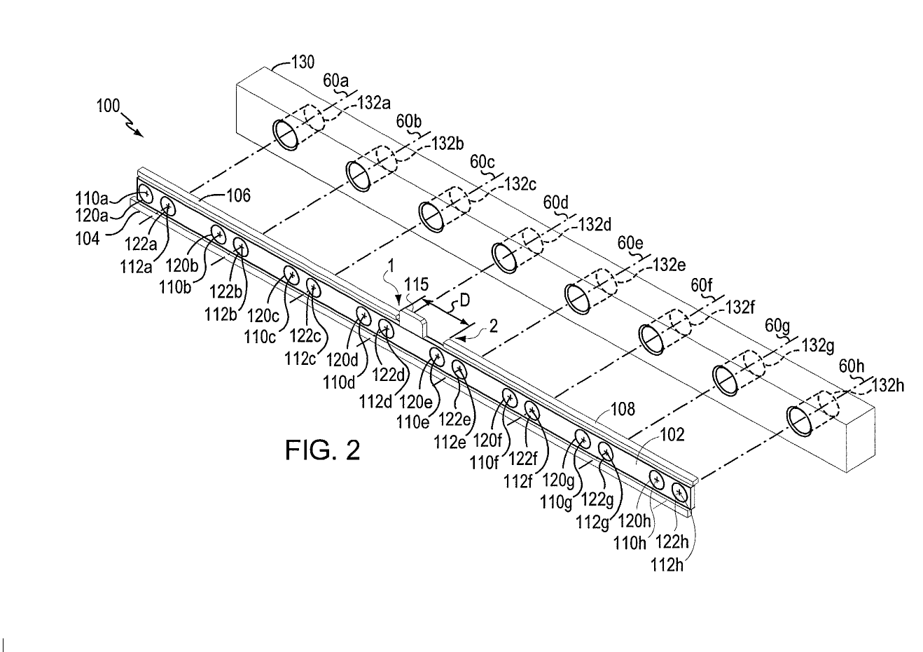

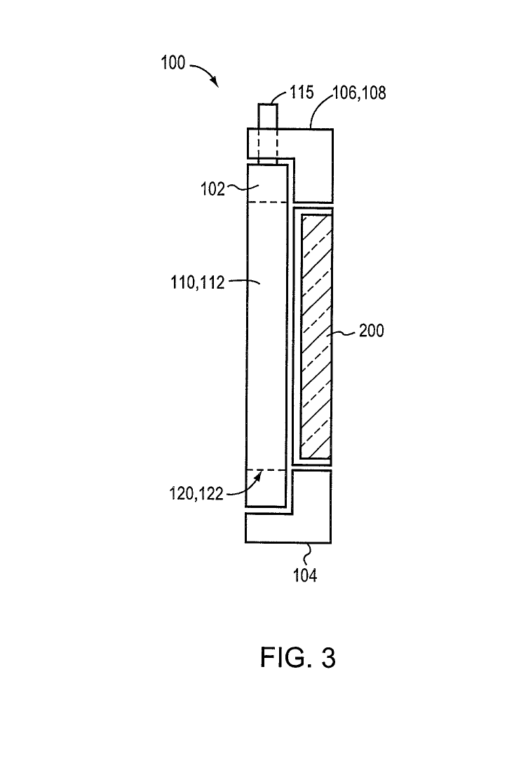

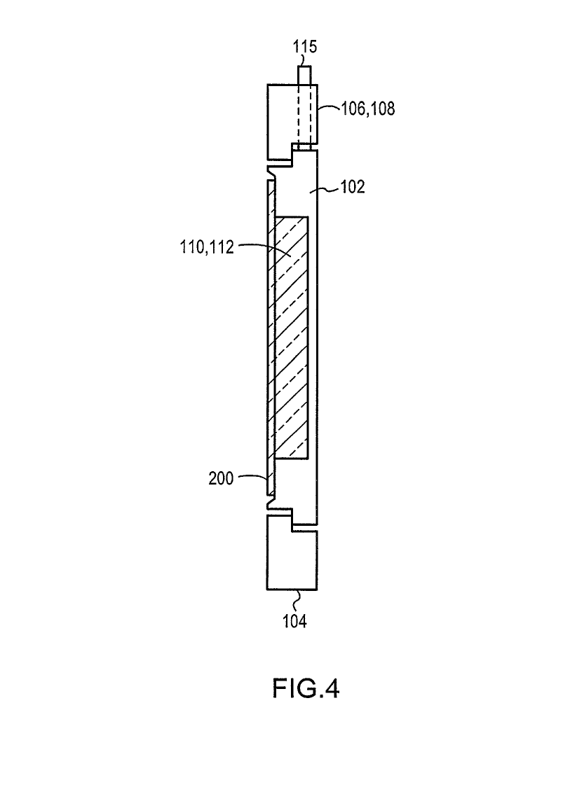

The components of a representative implementation of the invention, and the manner in which they may be applied to the arrangement schematically depicted in FIG. 1 (actually, to a device having several such arrangements), are illustrated in FIGS. 2 through 4. In particular, an optical indexing array 100 in accordance with the invention is depicted in an exploded view in FIG. 2, an elevational view in FIG. 3, and an elevational view of a preferred embodiment in FIG. 4. The entire assembly is interposed within the optical path between laser 20 and recording medium 10 (see FIG. 1). A generally planar filter strip 102 has a lower portion received within a lower linear channel 104 and an upper portion received within a first upper linear channel 106 and a second upper linear channel 108. Lower linear channel 104 extends longitudinally along the length of filter strip 102. First upper linear channel 106 and second upper linear channel 108 extend longitudinally along the length of filter strip 102, which includes a tab 115 projecting upward and located between first and second upper linear channels 106, 108. The width of tab 115 is smaller than the gap between channels 106, 108, allowing tab 115 to travel a distance D between the channels—i.e., between a first position (“position 1”) against channel 106 and a second position (“position 2”) against channel 108. As a result, filter strip 102 is slideable longitudinally along distance D between the channels.

Contained within the illustrated filter strip 102 are a first series of optical elements 110a-110h (hereafter collectively designated 110) and a second series of optical elements 112a-112h (hereafter collectively designated 112). First optical elements 110 are housed within the corresponding first circular filter strip apertures 120 and second optical elements 112 are housed within the corresponding second circular filter strip apertures 122. The centers of optical elements 110 and 112 are longitudinally spaced apart by distance D. First optical elements 110 and second optical element 112 have the same thickness but dissimilar energy density reduction characteristics. In one embodiment, first optical elements 110 are neutral density filters and second optical elements 112 are substantially transparent windows. In a preferred embodiment, at least one neutral density filter comprises a vapor-deposited metal coating. Optical elements 110, 112 desirably have substantially similar thicknesses and refractive indices so that the focal length of optical path 60 (FIG. 1) remains substantially the same; by “substantially” is meant, in this context, a variation of not more than ±5% and more preferably, not more than ±2%. Of course, the thicknesses and refractive indices of optical elements 110, 112 may vary with respect to each other so long as the overall result is maintenance of a substantially consistent focal length.

Alternative embodiments within the scope of the invention are possible. For example, filter strip 102 may include more than two sets of adjacent optical elements having different optical densities, so that each group of three or more optical elements provides a range of selectable output energy density reduction levels. In another embodiments, the filter associated with each indexing station characterized by a series of cylindrical bores 132a-132h (hereafter designated collectively as 132) have a density that increases progressively along the distance D, thereby providing a selectable continuum for reduction in the output energy density of the imaging radiation according to the longitudinal displacement of the unitary filter within the optical path. A numerical scale may be imprinted adjacent to tab 115 to allow the user to select a desired level of density reduction.

Indexing array 100 is affixed to an optical guide block 130 such that either optical elements 110 or 112 align with cylindrical bores 132 through optical guide block 130. The indexing optical element 100 contains multiple pairs of optical elements 110, 112 or “indexing stations” and a corresponding number of pairs of cylindrical bores 132 of optical guide block 130 in order to accommodate multiple optical paths 60a-60h. Each station contains at least two adjacent optical elements that may be selectably interposed within the optical paths. In this representation, there are eight substantially similar stations, but alternative embodiments may vary as to the number of indexing stations employed. In a preferred embodiment, indexing array 100 and guide block 130 are located between focusing lens 50 and support 12. However, indexing array 100 and block 130 may be disposed wherever desired along optical path 60.

A set of filter elements may be selectably interposed within the optical paths by sliding the actuator tab 115 along distance D, and accordingly, the filter strip 102 along lower linear channel 104 and upper linear channels 106, 108. Refer now to FIG. 3, which depicts the indexing optical element 100 in greater detail. An optical window 200 may be provided adjacent to filter strip 102 between upper linear channels 106, 108 and lower linear channel 104 in order to protect optical elements 110, 112 from a potentially harsh ambient environment. If desired, window 200 can be immovably affixed and disposed between lower linear channel 104 and upper linear channels 106, 108 as illustrated in FIG. 3, but FIG. 4 depicts a preferred embodiment wherein window 200 is affixed to the filter strip 102 and slides therewith.

In alternative embodiments, rollers, linear bearings or other friction-reduction elements are mounted along the interfacing surfaces between filter strip 102 and lower linear channel 104 on a lower surface and between filter strip 102 and upper linear channels 106 and 108 on an upper surface for ease of operation and to maintain close dimensional tolerances between filter strip 102 and channels 104, 106, and 108. In the representative embodiment of FIG. 2, the actuator tab 115 is located at either position 1 or position 2. In this embodiment, actuator tab 115 is toggled between position 1 and position 2, while the intermediate positions along distance D are not used. In an alternative embodiment, a means (not shown) for locking actuator tab 115 at any selected location between position 1 and position 2 is provided. In this embodiment, actuator tab 115 and the filter strip 102 are moved by manual operation. In still another embodiment, tab 115 is equipped with an automated means (not shown) for traversing between position 1 and position 2. For example, an interface associated with the automated means may allow the user to select a desired output energy density; in response, the automated means moves tab 115 into the appropriate position corresponding to the user's selection.

With renewed reference to the embodiment shown in FIG. 2, when the actuator tab 115 is at position 1, first optical elements 110 are interposed within the plurality of optical paths and the gap between the upper linear channels 106, 108 causes filter strip 102 to be positioned such that the centers of first optical elements 110 align with the centers of the cylindrical bores 132 of the optical guide block 130 along the plurality of optical paths. When the actuator tab 115 is at position 2, second optical elements 112 are instead interposed within the plurality of optical paths. In this way, the output energy densities of the source of imaging radiation are adjusted to the requisite level for different types of recording constructions without substantially altering the focal length of the plurality of optical paths. Applicable recording media include but are not limited to ablation-type plates, transfer-type plates and photochemical plates.

Although the present invention has been described with reference to specific details; it is not intended that such details should be regarded as limitations upon the scope of the invention, except as and to the extent that they are in included in the accompanying claims.

What is claimed is:

1. Apparatus for imaging a recording construction, the apparatus comprising:
a. a source of imaging radiation producing an output energy density;
b. a support for a recording construction;
c. means defining an optical path between the radiation source and the recording construction, the optical path having a focal length; and
d. within the optical path, a variable filter arrangement facilitating selectable reduction in the output energy density without substantially altering the focal length of the optical path.

2. The apparatus of claim 1 wherein the variable filter arrangement comprises a slideable assembly interposed in the optical path, the slideable assembly comprising:
a. at least one neutral density filter having a first thickness;
b. a substantially transparent window having a second thickness, the first and second thickness being substantially the same; and
c. a slideable means for selectably disposing the at last one neutral density filter or the transparent window within the optical path, thereby facilitating selectable reduction in the output energy density.

3. The apparatus of claim 1 wherein the at least one neutral density filter comprises a vapor-deposited metal coating.

4. The apparatus of claim 1 wherein the variable filter arrangement facilitates continual gradation of output energy density.

5. The apparatus of claim 1 wherein the variable filter arrangement comprises a unitary construction of progressive filter densities so as to provide a selectable continuum for reduction in the output energy density.

6. The apparatus of claim 1 wherein the selectable reduction in the output energy density ranges from 485 mJ/cm² to 80 mJ/cm².

7. The apparatus of claim 1 comprising a protective optical window adjacent to the variable filter arrangement.

8. The apparatus of claim 1 comprising a plurality of optical paths for a corresponding plurality of variable filter arrangements.

9. The apparatus of claim 1 wherein the source of imaging radiation is a laser device.

10. The apparatus of claim 1 wherein the support for the recording construction comprises a cylinder circumferentially surrounded by a recording medium.

11. For use in an apparatus for imaging a recording construction comprising a source of imaging radiation producing an output energy density, a support for a recording construction and means defining an optical path between the radiation source and the recording construction, the optical path having a focal length, a variable filter arrangement disposed within the optical path, the filter arrangement facilitating selectable reduction in the output energy density without substantially altering the focal length of the optical path.

12. The apparatus of claim 11 wherein the variable density filter arrangement comprises at least one filter medium and a substantially transparent window, the window and the filter medium having a substantially similar dimensional thickness along the optical path and a substantially similar refractive index.

13. The apparatus of claim 11 wherein the variable filter arrangement comprises a slideable assembly interposed in the optical path, the slideable assembly comprising:
a. at least one neutral density filter having a first thickness;
b. a substantially transparent window having a second thickness, the first and second thickness being substantially the same; and
c. a slideable means for selectably disposing the at last one neutral density filter or the substantially transparent window within the optical path, thereby facilitating selectable reduction in the output energy density.

14. The apparatus of claim 11 wherein the at least one neutral density filter comprises a vapor-deposited metal coating.

15. The apparatus of claim 11 wherein the variable filter arrangement facilitates continual gradation of output energy density.

16. The apparatus of claim 11 where in the variable filter arrangement comprises a unitary construction of progressive filter densities so as to provide a selectable continuum for reduction in the output energy density.

17. The apparatus of claim 11 wherein the selectable reduction in the output energy density ranges from 485 mJ/cm² to 80 mJ/cm²

18. The apparatus of claim 11 comprising a protective optical window adjacent to the variable filter arrangement.

19. The apparatus of claim 11 comprising a plurality of optical paths for a corresponding plurality of variable filter arrangements.

20. The apparatus of claim 11 wherein the source of imaging radiation is a laser device.

21. The apparatus of claim 11 wherein the support for the recording construction comprises a cylinder circumferentially surrounded by a recording medium.

22. A method of imaging a recording construction, the method comprising the steps of:
a. producing radiation with an output energy density and directed toward the recording construction along an optical path having a focal length;
b. interposing a variable density filter arrangement for selectable reduction in the output energy density; and
c. operating the filter arrangement to select an output energy density without altering the focal length of the optical path.

23. The method of claim 22 wherein the selectable reduction in the output energy density ranges from 485 mJ/cm² to 80 mJ/cm².

24. The method of claim 22 wherein the variable density filter arrangement comprises at least one filter medium and a clear lens, the lens and the filter medium having a substantially similar dimensional thickness along the optical path and a substantially similar refractive index.

25. The method of claim 22 wherein the source of imaging radiation is a laser device.
